(19) United States
(12) Patent Application Publication
(10) Pub. No.: US 2011/0246270 A1
(43) Pub. Date: Oct. 6, 2011

(54) SYSTEM AND METHOD FOR SOCIAL NETWORK MARKETING

(76) Inventor: RUSSELL KRYWOLT, VANCOUVER (CA)

(21) Appl. No.: 12/753,864

(22) Filed: Apr. 3, 2010

(51) Int. Cl. G06Q 30/00; G06Q 99/00

(52) U.S. Cl. 705/14.14

(57) ABSTRACT

A computer implemented marketing system disseminates information about a product or service over a computer network to a plurality of users who are encouraged to provide the marketer with their contact information in exchange for the possibility of obtaining a reward. Utilizing the relationships among users to encourage them to provide their information in an exponential, potential reward structure, the system contacts a large number of users in a short time. The user who wins the reward, and the user's referring party(ies), receive a reward for their participation and referrals. The method utilizes a computer network to generate identification codes for each user, validate the information of each user, and select the winner from among the referred users and the winner's referring party(ies).

### FIELD OF THE INVENTION

Embodiments of the present invention relate to a social network marketing system, in which information about a product or service is disseminated to a plurality of users who are encouraged to provide their contact information to the marketer in exchange for the possibility of obtaining a reward from the marketer. The system utilizes relationships among the users to encourage them to provide their information to the marketer, in a multi-level, exponential, potential reward structure. The result is that a large number of users can be contacted in a very short time, reducing the costs to the marketer. The user who wins the reward, and the user's referring party(ies) who meet eligibility criteria, receive a reward for their participation and referral of others. The method describes how to utilize the power of these relationships in a multi-level exponential reward structure.

### BACKGROUND OF THE INVENTION

Promotion, marketing, and awareness is the key starting pont for any business. The greatest product in the world will not make a business successful unless there are customers, and potential customers will not know the product exists without being exposed to the marketing and promotional messages of a company.

Current marketing methods primarily utilize non-specific distribution channels such as newspapers, television, radio, or internet banner ads to reach a broad audience.

One problem with this approach is that companies are paying large sums or money to organizations that have a large audience without being able to determine how many people the message might be delivered to, and, once delivered, have no way to determine how many people even noticed the message, much less what impact it had on the person. For example, newspapers, magazines, and television stations say that any advertising message will reach all the people who use their service. For newspapers and magazines, they cannot tell how many people who actually pick up a paper will ever flip past the page where any particular ad is being shown, nor can they tell if a person will even read the ad, if they happen to read something else on that page. Television stations have similar problems where they rely on broad statistical analysis to determine their audience in the first place, and they cannot be sure how many people watching a certain program will see the commercial, because the audience may flip channels during the breaks. Even if a person left the television on the station showing the ad, there is no way to tell if there was someone paying attention to the commercial and no way to measure the impact of that commercial in the unlikely event someone did indeed watch it.

To reach a more specific and targeted audience, companies employ several different strategies, several of which have become popular with the widespread adoption of internet marketing Companies wanting to reach an audience with specific interests can buy or rent lists of names and addresses (e-mail or regular mailing addresses). They compose a message that is meant to elicit a response from the recipient and direct them to reply to an e-mail address, or telephone number, if interested. In order to do this, companies must first find sources of these lists that match the criteria of their target audience or go to the effort and expense of creating them from scratch. Because the message is sent to a specifically identifiable group, the effectiveness of the campaign can be determined from the number of recipients that reply. While this method is good for promoting specific offers, it is not very effective for brand building.

Targeted banner ads can also reach an audience that has broadly defined interests if the ads are placed on websites that cater to that audience or if the audience of a general site can be somehow segmented by their interests. An example of the latter is search engines, where banner ads (including text-links employed by GOOGLE™) can be placed on a search results page where the ad has direct relevance to the terms used by the viewer's search query. For example, someone searching for “canoe” can be shown ads from outdoor outfitting companies, canoe or kayak rental companies, or businesses that provide recreational boating instruction. These types of ads can be paid for either on a impression basis (where every time the ad is shown to someone a small charge is incurred) or on a pay-per-click basis (where a charge is only levied when someone follows the ad from the point of display to the sponsoring company's website). The former method of payment is better for brand-building and pure exposure generation (as a credit card company might want) while the latter is more cost-effective for companies trying to create sales volume or other purpose for which they want someone to directly respond to their message.

Social networking marketing campaigns, sometimes referred to as “viral marketing” are a new phenomenon on the internet that companies are experimenting with. As has been seen in recent years, an internet website has a specific item posted on the website, and as more and more individual become aware of it, they communicate this to their friends and other contacts, using either the internet or other forms of communication. If a substantial number of hits start to occur on that website within a short time period, the broadcast news media will often say that the item has “gone viral”.

One assumes that the term “viral” originated based on a description of how a virus multiplies once it has invaded a host cell. Generally, a single virus particle enters the host cell, and the virus starts to replicate itself by utilizing the components of the cell. Once a sufficient number of new viral particles have been made inside the cell, the new viruses are released, and go on to infect other cells. In general, anywhere from tens to hundreds of new viral particles may be produced from a single virus. This exponential multiplication is, presumably, the basis of the concept of viral (social networking) marketing.

Through various types of advertising, companies usually try to come up with some media offering (a video, music, etc.) that appeal to a specific market segment in a way that the target audience will pick up the message and pass it on to their friends and associates. This form of social-network marketing so far has been hit-and-miss because overtly commercialized messages tend to generate a backlash against them (people perceive they are being manipulated into passing something on to their friends and associates) and insufficiently commercial messages, while potentially reaching a large audience, are not related back to a specific company or product by the viewers and thus have little impact.

The appeal of social networking (viral) marketing is that a minimal amount can be expended on the marketing campaign as the recipients of the marketing message are the catalysts for expending the audience of the message. To date, companies and advertising agencies have been unable to find a method for social networking (viral) marketing that produces consistent and measurable results.

The return on investment (“ROI”) for marketing efforts is typically measured in cost-per-lead (“CPL”) and generally describes the cost for a marketing campaign to get one individual to provide enough information to the company where they can be contacted directly by a salesperson. The lower the CPL of any marketing campaign, the greater success it can be said to have had. A follow-up metric for ROI is the cost-per-sale (“CPS”) which aggregates the cost of all marketing campaigns for a specific sales effort and determines how much money had to be spent in marketing and sales in order to get one person to buy a specific product or service from the company.

Depending on the type of marketing used, the CPL can be very high. For example, newspaper advertisements can have a cost of over $1000 per lead depending on the product or service being advertised. In one recent campaign conducted by this inventor, the cost of a newspaper ad campaign was approximately $600 per person that responded. For other campaigns, such as marketing via e-mail lists, the costs can vary greatly depending on the target market. Public companies that promote themselves via e-mail to lists of investors obtained from newsletter writers or stock-focused websites have historically been seeing a cost per lead of between $30 and $100. Targeted banner ads and text-links as described above are more economical, but still result in a CPL of between $10 and $50, on average.

Embodiments of the present invention include a system based on a contest where people signing up are also entered to win a prize (the specific prize to be determined by the sponsor of the marketing campaign, and could be based upon specific interests of the marketing campaign's target audience). In order to be eligible to win, a person must give some personal information and also give their permission to have their personal information used for marketing purposes (under whatever conditions the client specifies). Because of this focus, the system has been termed the “Giveaway Marketing Strategy” system (“GMS”).

While “enter-to-win” contests are not an uncommon marketing tool, most of the time these contests go hand-in-hand with other marketing efforts as outlined in the previous section. One can give away their product or service to generate interest, but one still needs to reach the masses of people in the targeted demographic.

The unique aspect this system adds to the contest is the component that creates the incentive for people to push the information about the contest to their circle of friends and associates.

The GMS system creates this incentive by ensuring that if a person refers their friends and associates, and those people sign up, if one of them wins, the original person wins as well. This continues throughout many levels of referrers. For example, if Bob referred Fred and Sam, and Sam referred George and Phil, and Phil ended up winning the contest, Sam would also win, and Bob would also win. This motivates an individual to tell as many of his associates about the contest so that it increases his own chances of winning exponentially. It also ensures that communications with associates are done showing a direct benefit to the associates (“Hey, you can win stuff!”) and minimizes or eliminates the negative impact of having a directly commercial message being communicated. It requires nothing from anyone other than some contact information and the permission to be contacted by the company sponsoring the promotion.

For example, if a company wanted to promote their products, it could use the GMS system and offer a prize of (for example) $500 worth of the company's merchandise. If the initial marketing was done to a single person that signed up two associates, and each of those signed up two others, and that continued, by the time 10 people in a direct referral chain had been contacted, a total of 2047 people would have signed up. By the time 20 people in a direct referral chain had been contacted, a total of 2,097,151 people would have signed up. By the time 30 people in a direct referral chain had been contacted, a total of 2,147,483,647 people would have signed up (if this were possible).

Assuming that, in a worst case scenario, the sponsoring company needs to pay for one prize per person in the referral chain, they would have to provide $10,000 in prizes for having over 2 million people sign up and provide their contact information. These leads could be contacted again with specific information about the sponsoring company's product. Contrast this to other websites with a significant user base that provides access to 100,000 names at a fixed cost of $10,000 merely to e-mail them with no guarantee of response. Considering the relative numbers of people reached by these marketing campaigns, it is clear that the GMS system comes in considerably more cost effective than even that type of targeted marketing.

### BRIEF SUMMARY OF THE INVENTION

Embodiments of the present invention have been created to address the problems associated with the currently available marketing methods outlined above. The system utilizes new relationship marketing concepts and implementations to create a directed, targeted and effective marketing campaign that can provide a potential increase to ROI of over 1000%.

Embodiments include a computer implemented marketing system that disseminates information about a product or service over a computer network to a plurality of users who are encouraged to provide the marketer with their contact information in exchange for the possibility of obtaining a reward.

The system does this by creating immediate and identifiable incentive for people to accept a promotional message and to communicate the message with their associates. It does this by providing a direct and tangible benefit to the recipient of the promotional message, which is also something that a person would believe to be of benefit to their friends with similar interests, and provides a unique and identifiable personal incentive for that individual to pass on the message. The system utilizes relationships among the users to provide their information, in a multi-level exponential potential reward structure. The result is that a large number of users can be contacted in a very short time, reducing the costs to the marketer. The user who wins the reward, and the user's referring party(ies) that meet eligibility criteria, receive a reward for their participation and referral of others. The method utilizes a computer network to generate identification codes for each user, validate the information of each user, and select the winner from among the referred users and the winner's referring party(ies).

The computer-implemented marketing method comprises the steps of:

utilizing a computing device in a network of computing devices, enrolling a seed population in a contest;

generating a seed code, the seed code identifying each member of the seed population;

requesting the seed population to communicate with one or more contacts and to encourage the one or more contacts to enroll in the contest;

enrolling the one or more referred contacts in the contest;

generating a referral code, the referral code identifying each of the one or more referred contacts;

validating the enrollment of the one or more referred contacts;

transmitting the referral code to the one or more validated referred contacts;

repeating the steps of requesting, enrolling, generating referral code, validating the enrollment, and transmitting the referral code for the duration of the contest;

terminating the contest at a specified time;

selecting a winner from among the validated referred individuals; and

wherein the step of selecting the winner further comprises the step of selecting either none, or one or more winners, from among the validated referred individuals in a referral chain with the selected winner.

### BRIEF DESCRIPTION OF THE SEVERAL VIEWS OF THE DRAWING

FIG. 1 is a schematic illustration of a computer network.

FIG. 2 is a schematic representation of a computing device.

FIG. 3 is a flow chart illustrating the initiation of a marketing campaign and creation of referral codes.

FIG. 4 is a flow chart illustrating how an individual participates in the system.

FIG. 5 is a flow chart illustrating the referral and user activation process.

FIG. 6 is a flow chart illustrating the winner selection process.

### DETAILED DESCRIPTION OF THE INVENTION

Embodiments of the present invention have been developed to address the previously described problems associated with currently available marketing methods. The system of the present invention utilizes new relationship marketing concepts and implementations to create a directed, targeted and effective marketing campaign that can provide a potential increase to the return on investment (“ROI”) of up to 1000% or more.

The system does this by creating an immediate and identifiable incentive for people to accept a promotional message and further to communicate the message with their associates. It does this by providing a direct and tangible benefit to the recipient of the promotional message, which is also something that a person would believe to be of benefit to their friends with similar interests, and provides a unique and identifiable personal incentive for that individual to pass on the message to their friends and associates.

The system is based on a contest where people signing up are entered to win a prize (the prize determined in part by the interests of the marketing campaign's target group). To be eligible to win, a person must give some personal information and also give their permission to have their personal information used for marketing purposes (determined by the campaign's sponsor). Because of this focus, the system has been termed the “Giveaway Marketing Strategy” system (“GMS”).

While “enter-to-win” contests are not an uncommon marketing tool, they are frequently associated with other marketing efforts as outlined previously. One can give away their product or service to generate interest, but one still needs to reach the masses of people in the targeted demographic.

Embodiments of the present invention add an element to the contest creating the incentive for people to push the information about the contest to their circle of friends and associates.

The GMS system creates this incentive by ensuring that if a person refers their friends and associates, and those people sign up, if one of them wins, the original person wins as well. This continues throughout many levels of referrers. For example, if Bob referred Fred and Sam, and Sam referred George and Phil, and Phil ended up winning the contest, Sam would also win, and Bob would also win. This motivates an individual to tell as many of his associates about the contest so that it increases his own chances of winning exponentially. It also ensures that communications with associates are done showing a direct benefit to the associates (“Hey, you can win stuff!”) and minimizes or eliminates the negative impact of having a directly commercial message being communicated. It requires that the individual provide their contact information and their permission to be contacted by the company sponsoring the promotion.

For example, if a company wanted to promote their products, it could use the GMS system and offer a prize of (for example) $500 worth of the company's merchandise. If the initial marketing was done to a single person that signed up two associates, and each of those signed up two others, and that continued, by the time 10 people in a direct referral chain had been contacted, a total of 2047 people would have signed up. By the time 20 people in a direct referral chain had been contacted, a total of 2,097,151 people would have signed up. By the time 30 people in a direct referral chain had been contacted, a total of 2,147,483,647 people would have signed up (if this were possible).

Assuming that, in a worst case scenario, the sponsoring company needs to pay for one prize per person in the referral chain, they would have to provide $10,000 in prizes for having over 2 million people sign up and provide their contact information. These leads could be contacted again with specific information about the sponsoring company's product. Contrast this to other websites with a significant user base that provides access to 100,000 names at a fixed cost of $10,000 merely to e-mail them with no guarantee of response. Considering the relative numbers of people reached by these marketing campaigns, it is clear that the GMS system comes in considerably more cost effective than even that type of targeted marketing.

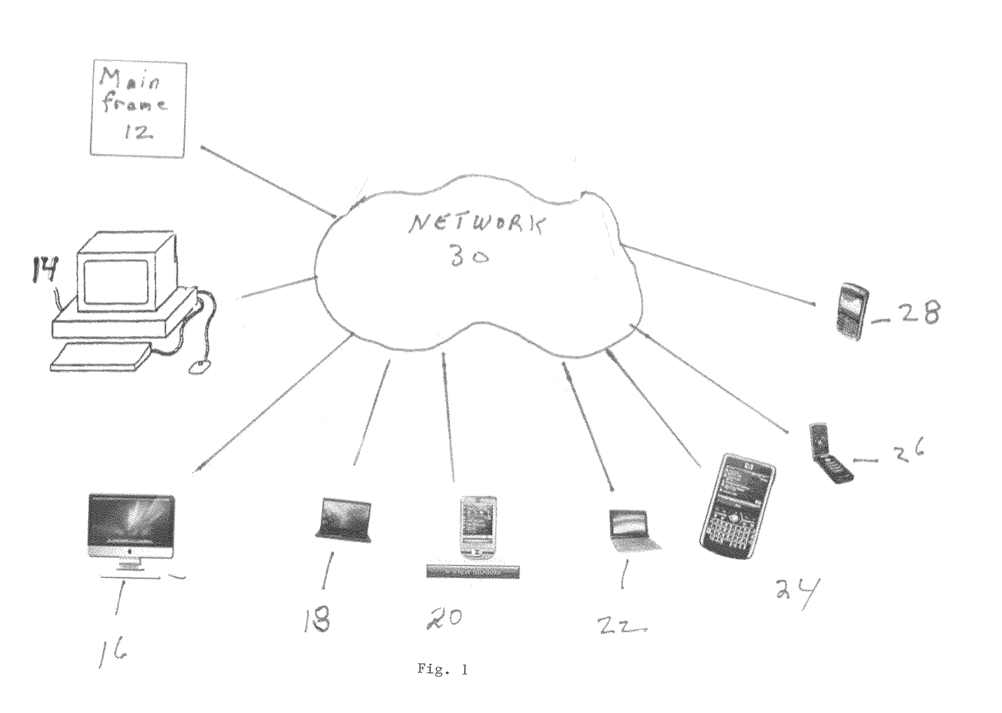

Embodiments of the present invention are designed for use with a computer system 10, as shown in FIG. 1. As used in the context of the present specification, the term computer or computing device will be used interchangeably, and is intended to have its broadest definition, and include any device that includes a microprocessor, an operating system, a display means, an input-output means, a memory, and a communications means. The communications means can be either a wired or a wireless communications means. The wireless communications means can be capable of receiving communications via any wireless means, such as, but not limited to, infrared signals, radio signals, microwave signals, telephone, video, satellite, and the like. The system and method take advantage of the speed of modern communications means to achieve the rapid spread of the promoted message among the individuals participating.

Embodiments of the present invention can be provided in the form of a computer-readable medium, such as on a flash memory device, a computer disk, a compact disk, read-only memory device (“CD-ROM”), a digital video disk (“DVD”), or as a file stored on a computer memory and distributed electronically over a communications network and stored in the memory of another computer, or as a file stored in the memory of a central computer and made available over a computer network to other users of that network. The communications network can be an Ethernet-enabled network, a private network, or a public network, such as the public telephone net, a cable network, a fibre optic network, a satellite mediated network, a wireless network, the internet, a cloud computing network, or other type of wired or wireless communications network, or combinations thereof.

Computer system 10 can include a mainframe computer 12, a personal computer 14, characterized by being an IBM® (registered trademark of International Business Machines Corp, Armonk, N.Y.) device or “IBM-compatible” computer, a MACINTOSH® or MAC® (registered trademark of Apple computer, Cupertino, Calif.) device computer 16, a portable computer 18 such as a laptop computer, a personal digital assistant (“PDA”) 20, a “netbook” computer 22, a hand-held computer device 24, a telephone 26, a “smartphone” 28, such as the BLACKBERRY® (registered trademark of Research In Motion, Ltd, Waterloo, Ontario, Canada) device or similar devices from other manufacturers, which are connected to network 30 by means of either a wired or wireless connection. One example of network 30 could be a world wide network, such as the internet, or a similar network in what is referred to as cloud computing.

Each computer in network 30 may also be connected to one or more computers in another, or secondary, network (not shown), which may also be either a wired or wireless network. One example of such a secondary network would be a computer connected to a network within a corporation or the like. Examples of a wired network include the use of an Ethernet link, a cable link, fibre optic link, telephone line or the like.

Embodiments of the present invention are capable of use on devices which include an operating system. The operating system may exist as software resident within the computer's memory, or stored elsewhere within the electronics of the computer. Among the possible, non-limiting, examples of operating systems are the operating systems for the Apple MACINTOSH® computers, IBM-compatible computers, operating systems such as Windows 3.1×, Windows 95, 98, Millennium, NT, 2000, VISTA®, Windows 7, the UNIX, LINUX or other open-source operating systems, and those operating systems found on the various models of telephones, such as the BLACKBERRY® or ANDROID® or comparable models. In one embodiment of the present invention, the system can operate under the WINDOWS® (registered trademark of Microsoft Corp., Redmond, Wash.) operating system. In other embodiments of the present invention, the system can operate under the operating systems of MACINTOSH® computers, UNIX, LINUX or other open-source operating systems, or various telephone operating systems recited above.

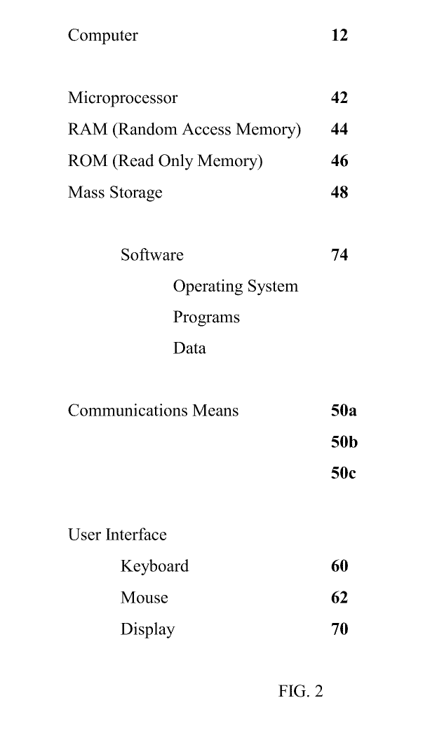

Referring to FIG. 2, the system 10 of the present invention employs a computer 12 equipped with a microprocessor 42, random access memory 44, read-only memory 46, a mass-storage device 48 such as a hard disk, a solid-state memory means, or a flash memory device, and a communications means 50 to enable the computer 12 to communicate with output devices such as a printer 52.

The communications means 50 may comprise a printer interface, which may be either a parallel interface, a serial interface, Universal Serial Bus (“USB”) or IEEE 1394 (“Firewire”) or the like, and an appropriate connection to the printer. The connection may be either a wired or wireless connection. A second communications means 50a may comprise a modem and serial port or SCSI (or SCSII), Universal Serial Bus (“USB”) or IEEE1394 interface enabling the computer 12 to communicate with communications network 30, such as a public telephone net, the Internet, an extranet, the world wide web or other wired or wireless communications system. Such communications means 50 may also comprise a cable modem and a connection to a cable service, an ISDN modem and ISDN line, a Digital Subscriber Line (“DSL”) modem and DSL line, T-1 line, and the like. The system may further include an input means such as keyboard 60, a mouse 62, or similar device such as a Touch-Pad or pointing device such as the ACCUPOINT® (Registered Trademark of Toshiba America Information Systems, Inc. for a cursor control device for computers, attached to the computer keyboard), or touch-pad interface, scanner (not shown), and a visual display means 70 such as a Liquid Crystal Display (“LCD”), cathode ray tube (CRT) monitor or video display terminal, a dual-scan monitor, thin-film transistor, active-matrix monitor, electronic glasses, or their equivalents. Software 74 which is resident in the computer's memory, or which may be stored in the memory of another computer such as a server in a computer network or other central computer includes the operating system necessary for operation of the computer. The possible operating systems have been described in a previous paragraph, and that listing is not intended to be exclusive, as the system can be adapted to newer operating systems that are being developed now or in the future.

Embodiments of the system may be deployed as a computer-readable medium, such as on a diskette, CD-ROM, DVD, flash memory device, magnetic cards or magnetic tape, or other formats currently in use and known to those skilled in the art, or to be developed in the future. Embodiments of the present invention may also be deployed on a computer, or stored in the memory of a computing device, whether a computer server, individual computer, mainframe computer or supercomputer.

The criteria for a marketing campaign will be determined by the campaign's sponsor, and generally includes such demographic information as the age and/or gender of the targeted audience, education, marital status, number of children, number of pets, occupation, income levels, geographic locations, political, religious, or social affiliations, and/or other parameters, or combinations thereof, known to those skilled in the arts for marketing, advertising, and promotion of products and/or services. The individuals who will be contacted will be those who have consented to be contacted for marketing purposes, in compliance with appropriate local laws and regulations.

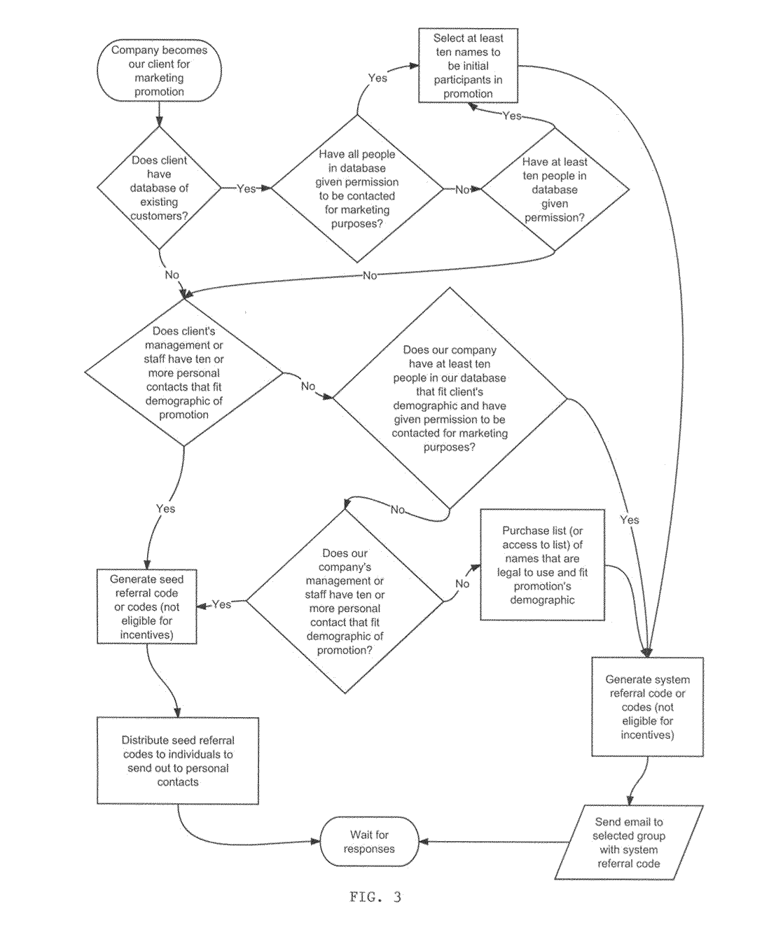

The method of the present invention is used in the following manner (FIGS. 3-6).

In one embodiment of the present invention, a campaign is started with a seed population. A campaign can be started with only a single individual. In another embodiment of the present invention, a campaign can be started with as few as 5-6 individuals. In another embodiment of the present invention, a campaign can be started with 10 individuals. In still another embodiment of the present invention, a campaign can be started with 10 or more individuals, but generally less than 100. A campaign could be initiated will a seed population in excess of 100 individuals. Preliminary data suggests that a group of 5-6 individuals is a “good” starting point to have an effective campaign; starting with a group of 10 or more would be based on statistical sampling methods that have been applied to surveys. In an embodiment of the present invention, 10,000 unique individual responses were generated within a one day period by sending six initiating messages.

The individuals in this initial group will be referred to herein either as “seed individuals” or the “seed population”, which terms will be used interchangeably herein, and their information identified by a seed code. The system notifies the members of the seed population about the subject matter of the campaign, and the members of the seed population are asked to contact other individuals about the campaign subject matter. In one embodiment of the present invention, members of the seed population are given a seed referral code, indicating they are members of the seed population, and not eligible for an incentive (or prize). In another embodiment of the present invention, members of the seed population are given a different seed referral code, indicating they are members of the seed population, and that they may be eligible for an incentive (or prize). Members of the seed population communicate with one or more individuals with whom they have contact, using any one of a number of communications means. Such communication means include, for example, and not intended as any limitation, electronic mail, instant messaging, text messaging, video, orally, various types of written communication, telephony and the like. The communication means is also intended to cover messages sent to individuals within such social networks as, for example only, MYSPACE FACEBOOK® and LINKED-IN®, or various peer-to-peer networks. One way in which contacts may be selected is from among the contacts contained in one or more computing devices of the seed individuals, or from another types of contacts list maintained by the seed individual, such as a “black book” or business diary or the like.

The contact information for persons in the seed population can be obtained from one or more sources, ranging from a list supplied by the campaign's sponsor, from among the sponsor's personnel, from the system supplier's own database(s) or individuals' contacts, or obtained from a commercial source (FIG. 3). Any one or more of these sources can be utilized; the aim is to obtain a base number of individuals who are willing to participate in the campaign, and the order recited in the drawing does not have to be the order from which the participating individuals are selected.

Assuming that members of the seed population contact one or more other individuals, these referred individuals will also contact the system. The system also prepares a series of referral codes, both for the seed population, and for the referred population.

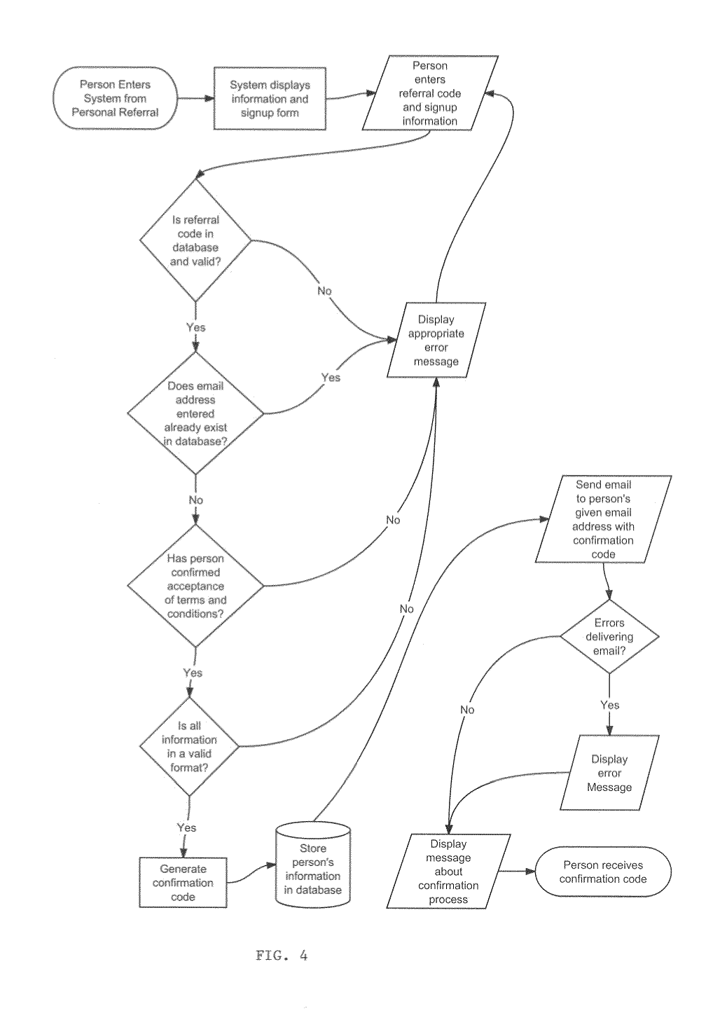

Referring to FIG. 4, using a computer with a communications means, a referred individual accesses the GMS system 100. Upon access to the system, the individual's computer displays the appropriate system information, and a signup form for the individual to complete.

The referred individual enters their relevant data, including their e-mail address, and the referral code that they had received, into the system. The relevant data will generally include the individual's name and address, telephone number, e-mail address, and other information that the sponsor of the campaign may be seeking, such as age, gender or the like. The system determines whether the referral code is valid, and if it is not valid, displays an error message. The error message could be a request to reenter the information, check the information with the referring individual, or to contact customer service for further assistance.

If the referral code is validated, the system determines whether that e-mail address has already been entered into the system and is stored in a database appropriate to the particular marketing campaign. If that e-mail address is already in the database, the system displays an error message. The error message could be a warning that the e-mail address is already in the system, and that a duplicate entry will not be accepted; a request to reenter the information, using an alternate e-mail address; or to contact customer service for further assistance.

If the e-mail address is not contained in the system, the referred individual is shown a screen, or a link to a screen, that contains the terms and conditions for entry into the campaign. The referred individual must accept the specified terms and conditions, or their entry will be refused, after which an error message is displayed. The error message will be a warning that in order to be entered, the specified terms and conditions must be accepted, and request that the individual review the terms and conditions again, and accept them.

After the referred individual accepts the terms and conditions, the system checks that all of the information entered is in a valid format, and if it is, the system stores the individual's information in the appropriate database. If the information is determined not to be in a valid format, the system will generate an error message indicating that the information is not properly entered, and will advise the referred individual which parameter(s) need to be corrected in order to proceed.

If the information is in a valid format, after the information is stored in the database, the system generates a confirmation code which is transmitted to the referred individual using the e-mail address that was provided by that individual.

If there is an error in delivering the e-mail message to the referred individual, an error message is displayed to referred individual, and a notification is sent to the system's administrative personnel.

If the message with the confirmation code is successfully delivered, a message is displayed that the confirmation process has been completed, and provides the referred individual with their confirmation code.

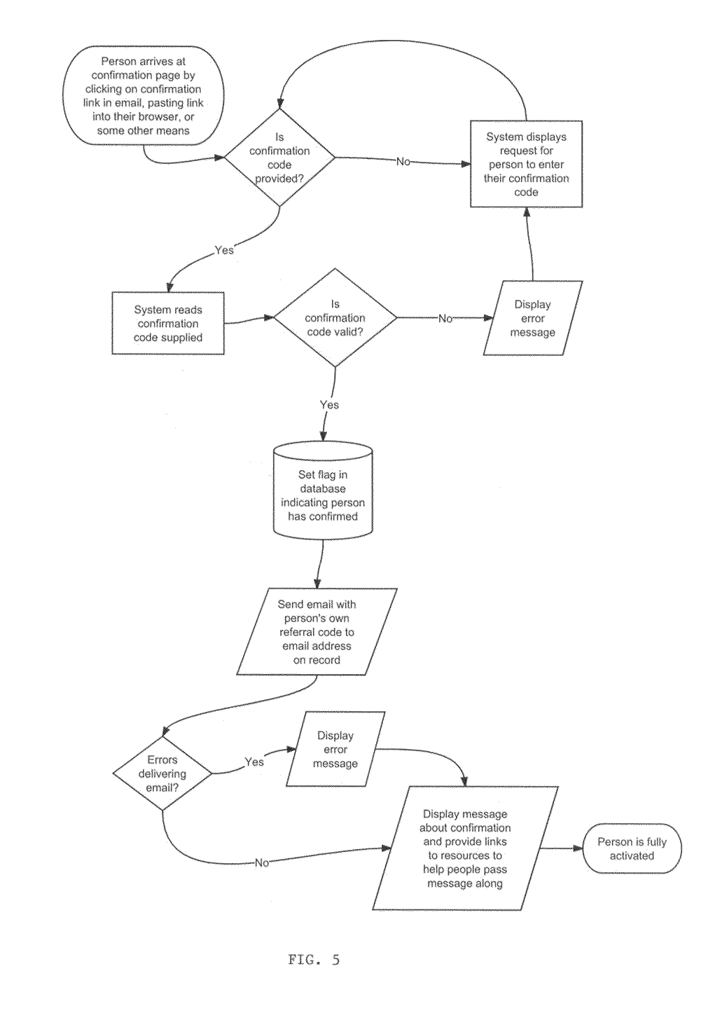

As shown in FIG. 5, once the referred individual receives the confirmation code, which can be, for example, an actual code within an e-mail message, or a confirmation link in the e-mail message, the message being generated by the system, the referred individual enters that confirmation code into the system. Entry of the confirmation code can be done such as by clicking on the link provided in the e-mail message, or by cutting and pasting the link into a web browser, and then clicking on that link. The system then verifies whether the confirmation link has been provided, and if so, the confirmation code is read by the system, and the validity of the confirmation code determined.

If the confirmation code was determined to be invalid, the system displays an error message, and requests that the individual enter their confirmation code, and this portion of the process is repeated until a successful entry occurs.

If no confirmation code was provided, the system will send an error message, requesting that the individual enter their confirmation code, and this is repeated until either a successful entry occurs, or the individual stops trying.

If the confirmation code is valid, the system sets a flag in the appropriate database, indicating that the individual has been confirmed, and an e-mail is sent to the person who is entering the contest with the person's own referral code to the e-mail address on record. As shown in the figures, the referral code is generated during the referred person's initial signup with the system, but the referral code is sent to the referred person once their registration has been confirmed by the system.

If there is an error in delivering the e-mail message to the referring individual, an error message is displayed. If the message with the referral code is successfully delivered, it displays a message about the confirmation and provides links to resources to help people pass the message along, the result being that the referred individual is fully activated.

This process of entry, generation of confirmation codes and referral codes continues in an iterative process, for the duration of the contest, as additional seed population members and referred parties continue to enter the system.

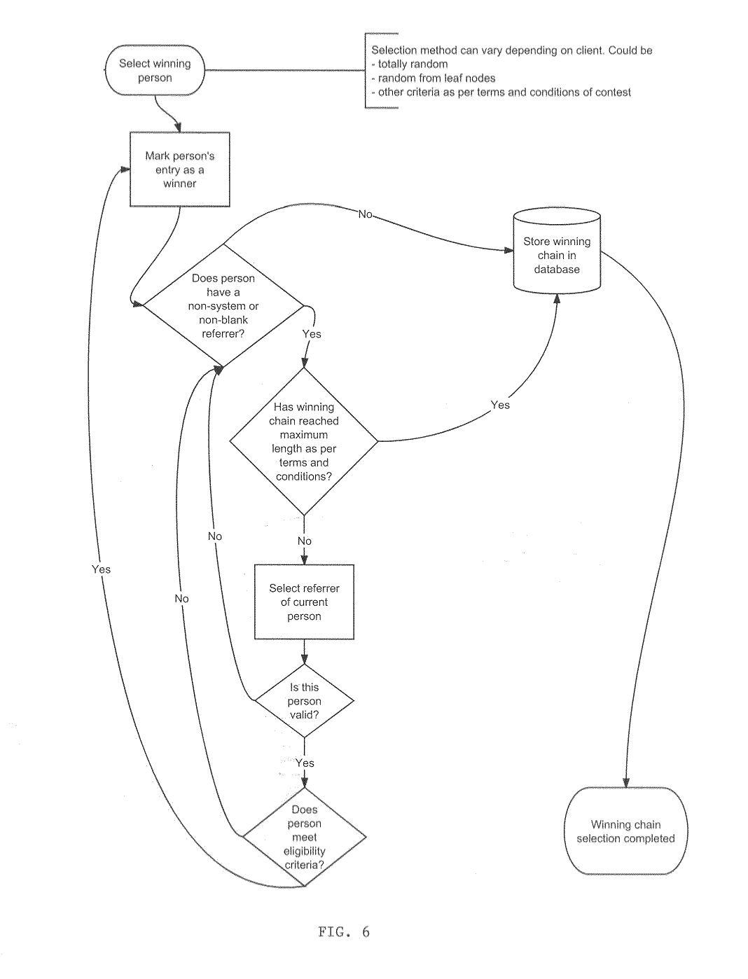

The duration of the contest, and the selection method for determining the winner of the contest, are determined by the sponsor (FIG. 6). A default set of rules may be, for example only and not intended to be any limitation, that a contest runs for 7 days (a day being defined in this instance as a 24 hour period), and that the winner is determined by means of a random referral code, chosen by a random number generating algorithm stored in one of the system's databases. Other methods for determining and choosing a winner are known to those skilled in the art, and will not be discussed further.

At the specified time, a winning person is selected from among the entries. Among the criteria that could be used to select the winning person are a totally random selection, a random selection from leaf nodes, or any other criteria that are specified by the client, provided they meet whatever rules are in effect in the jurisdiction in which the contest is being held. For purposes of this specification, the term “leaf node” will be used to refer to people who have signed up for the GMS and are fully activated, but who have not activated referrals by the time the contest has closed.

Once the winning person is chosen, the system marks that person's entry as a winner, and determines the referral status of the winning person. If the answer is “Yes” to whether the person has a non-system or a non-blank referral, the winner's information is stored in the appropriate database.

Is the winning person has a non-system or a non-blank referral, the system determines if the allowed numbers of winners have been reached (has winning chain reached its maximum length?).

If the winning chain has not reached its maximum length, the referrer of the current person is selected, and their entry validated. If the entry is validated, and then determined to meet the eligibility criteria, the referrer is marked as a winner, and entered into the winning chain within the system's database. This process is repeated as many times as necessary until the winning chain has been completed.

Once the winning chain has been completed, the winners are each notified that they have won a prize and are then notified of the prize and how it will be delivered to them. Notification of the winners can be done using an e-mail message, text message, telephone call, letter, or other means of notification established by the terms of the contest.

As a computer readable medium, embodiments of the present invention comprise a set of instructions for implementing a marketing campaign, and a set of instructions for the computer device which will effect the marketing campaign. Thus, an embodiment comprises at least one instruction for implementing a marketing campaign on a first computing device of a computer network; an instruction for identifying a seed population; an instruction for communicating marketing information to the seed population; an instruction for enrolling the seed population in a contest; an instruction for generating a seed code, the seed code identifying each of the seed population; an instruction for requesting the seed population to communicate with one or more contacts and to encourage the one or more contacts to enroll in the contest; an instruction for enrolling the one or more referred contacts in the contest; an instruction for generating a referral code, the referral code identifying each of the one or more referred contacts; an instruction for validating the enrollment of the one or more referred contacts; an instruction for transmitting the referral code to the validated referred contact; an instruction for repeating the steps of requesting, enrolling, generating referral code, validating the enrollment, and transmitting the referral code for the duration of the contest; an instruction for terminating the contest at a specified time; an instruction for selecting a winner from among the validated referred individuals; and an instruction for storing the enrollment information of the seed population, the validated referred contacts, and the selected winner in a database.

### Additional Features

In addition to the functions described in the preceding sections of this specification, it is anticipated that the present invention could include features that will enable the system to do the following:
Manage the relationships between people for purposes of tracking signups and referrals;
Incorporate advanced risk-management strategies for referral chain structures to prevent unbalanced referral trees;
Limit fraudulent activity, or “gaming” of the system, that would unduly favor certain individuals in the giveaway and limit the usefulness of the campaign;
Provide registered participants in the campaign ways of being able to see how their referral chain is progressing; statistics about the makeup and structure of their referral chain, and ways to use the system to bring others into their referral chain;
Provide a flexible system that can select winners through a variety of methods that may be desired by those who are employing the system to promote their business(es);
Produce statistical results during and at the conclusion of a campaign;
Maintain privacy of registered participants' personal information, and to do so in compliance with national requirements;
Deliver lists of registered participants to the client at the completion of a campaign;
Aggregate registered participants to a central database for selective remarketing usage;
Incorporate hooks to allow for secondary revenue streams (such as ads in registration pages, text links in follow up e-mails, etc.);
Allow the marketing system to integrate into existing personal relationship networks such as, but not limited to, MYSPACE, FACEBOOK®, LINKEDIN®, TWITTER®, and the like to enable those networks to be used to spread the clients' messages faster and more effectively;
Provide statistical information to the client about campaign effectiveness, rate of spread, feedback from participants, etc.; and
Produce lists of prize winners for clients and track prize fulfillment.

Many of the functions described above, such as, for example only, management of the relationships between people for purposes of tracking signups and referrals; delivery of lists of registered participants to the client at the completion of a campaign; aggregation of registered participants to a central database; and the provision of statistical information, could be performed by products currently available from third party vendors

It is anticipated that embodiments of the present invention could be capable of supporting numerous (for example, hundreds) campaigns going on at once and also be able to track and manage all of the (possibly millions) of registered users per campaign.

### Target Audience

The potential clients for embodiments of the present invention are vast in number and have varied business needs. It is anticipated that from large to small, almost every business in every industry could use embodiments of the present invention to generate awareness, leads, and ultimately sales at incredible effectiveness and cost savings when compared to traditional marketing efforts.

At the time that this specification is being prepared, the global economy is recovering from major economic problems. Because of these economic conditions, many, if not all, of these marketing service companies have felt the effects of clients restricting their own marketing budgets and trying to find means to stretch their marketing dollars farther. As a result, such service organizations can be expected to want to utilize embodiments of the present invention to enable them to continue to service their clients, and to do so in a way that is attractive to their clients, thus giving these service providers additional revenue than they might otherwise be able to earn in this time of economic uncertainty.

These partnerships can be formed at a local, national, or international level, providing great leverage and enabling rapid growth.

Although this invention has been described with a certain degree of particularity, it is to be understood that the present disclosure has been made only by the way of illustration, and that numerous changes in construction and arrangement of parts may be resorted to without departing from the spirit and scope of the invention.

I claim:

1. A computer-implemented marketing method, the method comprising the steps of:
utilizing a computing device in a network of computing devices, enrolling a seed population in a contest;
generating a seed code, the seed code identifying each member of the seed population;
requesting the seed population to communicate with one or more contacts and to encourage the one or more contacts to enroll in the contest;
enrolling the one or more referred contacts in the contest;
generating a referral code, the referral code identifying each of the one or more referred contacts;
validating the enrollment of the one or more referred contacts;
transmitting the referral code to the one or more validated referred contacts;
repeating the steps of requesting, enrolling, generating referral code, validating the enrollment, and transmitting the referral code for the duration of the contest;
terminating the contest at a specified time;
selecting a winner from among the validated referred individuals; and
wherein the step of selecting the winner further comprises the step of selecting either none, or one or more winners, from among the validated referred individuals in a referral chain with the selected winner.

2. The method as described in claim 1, further comprising the step of storing the enrollment information of each of the seed population and each of the validated referred contacts in a database of the computing device.

3. The method as described in claim 2, wherein the step of generating a referral code further comprises generating a confirmation code for the validated referred contact to provide to the one or more contacts to utilize when the one or more contacts enrolls in the contest.

4. The method as described in claim 2, wherein the validating step further comprises the step of determining whether the enrollment information of the one or more referred contacts is already included in the database.

5. The method as described in claim 4, wherein the validating step comprises the step of providing the individual with a term and condition for acceptance into the contest.

6. The method as described in claim 5, wherein the validating step further comprises the step of accepting the term and condition for acceptance.

7. The method as described in claim 4, further comprising the step of generating a confirmation code after the validation step.

8. The method as described in claim 1, wherein the network comprises the internet.

9. The method as described in claim 1, wherein the network comprises the world wide web.

10. The method as described in claim 1, wherein the network comprises one or more different computing devices.

11. A system, comprising:
a means for implementing a marketing campaign on a first computing device of a computer network;
a means for identifying a seed population;
a means for communicating marketing information to the seed population;
a means for enrolling the seed population in a contest;
a means for generating a seed code, the seed code identifying each member of the seed population;
a means for requesting the seed population to communicate with one or more contacts and to encourage the one or more contacts to enroll in the contest;
a means for enrolling the one or more referred contacts in the contest;
a means for generating a referral code, the referral code identifying each of the one or more referred contacts;
a means for validating the enrollment of the one or more referred contacts;
a means for transmitting the referral code to the validated referred contact;
a means for repeating the steps of requesting, enrolling, generating referral code, validating the enrollment, and transmitting the referral code for the duration of the contest;
a means for terminating the contest at a specified time;
a means for selecting a winner from among the validated referred individuals; and
a memory means for storing the enrollment information of the seed population, the validated referred contacts, and the selected winner.

12. The system as described in claim 11, wherein the means for enrolling the seed population and the means for enrolling the one or more referred contacts is a computing device.

13. The system as described in claim 12, wherein the means for enrolling the seed population and the means for enrolling the one or more referred contacts is a computing device other than the first computing device.

14. The system as described in claim 12, wherein the means for selecting the winner selects one or more winners from among the validated referred individuals in a referral chain with the selected winner.

15. The marketing system as described in claim 14, wherein the means for selecting the winner excludes the member of the seed population in the referral chain with the selected winner.

16. The system as described in claim 11, wherein the seed population comprises a group ranging in size from 1 to less than 100 individuals.

17. The system as described in claim 16, wherein the seed population comprises a group ranging in size from 1 to 20 individuals.

18. The system as described in claim 17, wherein the seed population comprises a group ranging in size from 2 to 10 individuals.

19. The system as described in claim 18, wherein the seed population comprises a group ranging in size from 5 to 6 individuals.

20. The system as described in claim 12, further comprising a means for validating the winner.

21. A computer readable medium for implementing a marketing method, the computer readable medium comprising:
at least one instruction for implementing a marketing campaign on a first computing device of a computer network;
an instruction for identifying a seed population;
an instruction for communicating marketing information to the seed population;
an instruction for enrolling the seed population in a contest;
an instruction for generating a seed code, the seed code identifying each of the seed population;
an instruction for requesting the seed population to communicate with one or more contacts and to encourage the one or more contacts to enroll in the contest;
an instruction for enrolling the one or more referred contacts in the contest;
an instruction for generating a referral code, the referral code identifying each of the one or more referred contacts;
an instruction for validating the enrollment of the one or more referred contacts;
an instruction for transmitting the referral code to the validated referred contact;
an instruction for repeating the steps of requesting, enrolling, generating referral code, validating the enrollment, and transmitting the referral code for the duration of the contest;
an instruction for terminating the contest at a specified time;
an instruction for selecting a winner from among the validated referred individuals; and
an instruction for storing the enrollment information of the seed population, the validated referred contacts, and the selected winner in a database.
